(19) United States
(12) Patent Application Publication
(10) Pub. No.: US 2026/0332491 A1
(43) Pub. Date: Oct. 22, 2026

(54) DYNAMIC NETWORK SWITCH OPTIMIZATION USING REAL-TIME TELEMETRY

(71) Applicant: Aureka, Inc., Palo Alto, CA (US)

(72) Inventors: Subhachandra Chandra, Palo Alto, CA (US); Mansour Karam, Menlo Park, CA (US); Shrey Shah, San Jose, CA (US); James S. Cross, San Francisco, CA (US); Shane Rogers, Mountain View, CA (US)

(21) Appl. No.: 19/644,979

(22) Filed: Apr. 10, 2026

Related U.S. Application Data
(60) Provisional application No. 63/789,855, filed on Apr. 16, 2025.
(60) Provisional application No. 63/829,133, filed on Jun. 24, 2025.

(51) Int. Cl. H04L 41/16; H04L 41/0816

(52) U.S. Cl. CPC H04L 41/16; H04L 41/0816

(57) ABSTRACT

A method for generative AI-driven network optimization is described. The method includes detecting a trigger event, gathering contextual data in response to the trigger event, using a generative machine learning model to generate an actionable plan for modifying an operational state of a network environment based on the trigger event and the contextual data, and automatically executing the actionable plan by interfacing with one or more network components to modify the operational state of the network environment.

### CROSS REFERENCE TO OTHER APPLICATIONS

This application claims priority to U.S. Provisional Patent Application No. 63/789,855 entitled DYNAMIC NETWORK SWITCH OPTIMIZATION USING REAL-TIME TELEMETRY filed April 16, 2025 which is incorporated herein by reference for all purposes, and this application claims priority to U.S. Provisional Patent Application No. 63/829,133 entitled GENERATIVE AI-DRIVEN NETWORK OPTIMIZATION filed June 24, 2025 which is incorporated herein by reference for all purposes.

### BACKGROUND OF THE INVENTION

Data centers are experiencing unprecedented demands due to the proliferation of artificial intelligence (AI) workloads. Traditional networking architectures designed for general-purpose computing struggle to meet the unique communication patterns and bandwidth requirements of modern AI applications. AI applications, particularly those involving distributed training across multiple nodes, exhibit communication patterns that differ significantly from traditional client-server interactions. These workloads are characterized by frequent all-to-all communication, collective operations, and bursty traffic patterns. Additionally, different phases of AI workflow including data ingestion to training to inference have varying networking requirements, further complicating network design. This causes a problem when networking systems incur network congestion and performance degradation as a result of modern application requirements.

### BRIEF DESCRIPTION OF THE DRAWINGS

Various embodiments of the invention are disclosed in the following detailed description and the accompanying drawings.

FIG. 1 is a diagram illustrating an embodiment of a system for generative AI-driven network optimization.

FIG. 2 is a diagram illustrating an embodiment of a system for generative AI-driven network optimization within a network environment.

FIG. 3 is a diagram illustrating an embodiment of a workflow for generative AI-driven network optimization.

FIG. 4A is a flow diagram illustrating an embodiment of a process for generative AI-driven network optimization.

FIG. 4B is a flow diagram illustrating an embodiment of another process for generative AI-driven network optimization.

FIG. 5 is a flow diagram illustrating an embodiment of a process for generating an actionable plan for modifying the operational state of a network environment.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Networking has been reimagined for the Artificial Intelligence (AI) era: optimized for AI clusters end to end, powered by AI software, and built using AI to speed up innovation. This innovation includes a full-stack networking solution that comprises switches and networking control and management software that self-optimizes and self-automates the network end to end - including switches and network interface controllers (NICs) - interacting with the compute accelerator software and the job scheduler northbound. For example, this software layer can build a more sophisticated, capable, and scalable version of an InfiniBand network manager (e.g., subnet manager) for Ethernet. A highly scalable framework includes fine-grained telemetry collection, a distributed data store that processes, stores, and aggregates all telemetry, and a processing AI engine that trains on this telemetry and dynamically configures the network to meet the parameters of an objective function specified by the end user, with the goal of optimizing the network for a given use case.

These innovations pioneer AI telemetry driven networking, which features a new approach to controlling a network. When a network operator specifies a use case, the appropriate "objective function" is automatically chosen based on the use case, and appropriate AI model specialized in optimizing this objective function is automatically loaded. The model runs continuously, fed by real-time fine-grained telemetry collected from the network and the cluster itself, and adjusts the control and configuration parameters of the network in real time to meet the objective function. The control changes happen in real-time and much faster than with standard protocols. For example in machine learning model training, an objective function may be minimizing congestion while predicting component failures and routing around them, with the overarching goal of minimizing the training time of the jobs on the cluster.

Data centers are experiencing unprecedented demands due to the proliferation of artificial intelligence (AI) workloads. Traditional networking architectures designed for general-purpose computing struggle to meet the unique communication patterns and bandwidth requirements of modern AI applications. While InfiniBand has historically been preferred for high-performance computing environments, the industry is increasingly shifting toward Ethernet-based solutions for AI infrastructure.

InfiniBand networks deliver high throughput, low latency, and reliable connectivity for data-intensive applications. However, their proprietary nature, higher costs, and ecosystem limitations have driven data center operators to explore alternatives offering greater flexibility and interoperability with existing infrastructure. Ethernet, as an established and widely adopted networking standard, provides a compelling alternative. Recent Ethernet advancements have narrowed the performance gap with InfiniBand while offering advantages in compatibility, cost-effectiveness, and ecosystem support. Nevertheless, traditional Ethernet implementations still struggle to meet the dynamic networking requirements of modern AI workloads. AI applications, particularly those involving distributed training across multiple nodes, exhibit communication patterns that differ significantly from traditional client-server interactions. These workloads are characterized by frequent all-to-all communication, collective operations, and bursty traffic patterns that can lead to network congestion and performance degradation. Additionally, different phases of AI workflow including data ingestion to training to inference have varying networking requirements, further complicating network optimization.

AI applications, particularly distributed training across multiple nodes, exhibit communication patterns significantly different from traditional client-server interactions. These workloads feature frequent all-to-all communication, collective operations, and bursty traffic patterns that can cause network congestion and performance degradation. AI applications are sensitive to network congestion and performance degradation as any slowdown in one network node slows down the entire workflow. Furthermore, different phases of AI workflows, from data ingestion to training to inference, have varying networking requirements, further complicating network optimization. Data center networks typically employ static configurations unable to adapt in real-time to changing application demands. Network resources are often provisioned based on peak requirements, resulting in inefficient utilization during lower demand periods. Additionally, existing network management systems lack the intelligence to predict traffic patterns and proactively allocate resources to prevent bottlenecks before they occur. There remains a critical need for networking solutions that can dynamically adjust to the changing communication patterns of AI workloads while maintaining compatibility with existing infrastructure. Such solutions may enable real-time bandwidth allocation, intelligent congestion management, and predictive resource provisioning to ensure optimal performance across diverse AI applications.

A method for generative AI-driven network optimization is described. The method includes detecting a trigger event, gathering contextual data in response to the trigger event, using a generative machine learning model to generate an actionable plan for modifying an operational state of a network environment based on the trigger event and the contextual data, and automatically executing the actionable plan by interfacing with one or more network components to modify the operational state of the network environment.

In some embodiments, detecting the trigger event comprises monitoring telemetry data streams from network switches and identifying at least one of: anomalous traffic patterns that deviate from historical baselines; performance degradation trends indicating emerging network issues; new application workload signatures requiring specialized optimization strategies; or correlation patterns between disparate network events suggesting systemic issues.

In some embodiments, gathering contextual data comprises querying data sources including one or more of the following: telemetry data associated with baseline behaviors and trend patterns; current network topology and configuration states across managed devices; application-level metrics from connected servers and workload managers; or real-time correlation analysis between the trigger event and concurrent network activities.

In some embodiments, the generative machine learning model is one of a plurality of domain specific machine learning models. In some such embodiments, the plurality of domain specific machine learning models includes at least one of the following: an orchestrator model for tool selection, a specialist model for domain tasks, and a utility model for validation.

In some embodiments, generating the actionable plan comprises using the generative machine learning model to perform one or more of the following: analyzing the gathered contextual data in the context of network optimization objectives; evaluating multiple optimization strategies simultaneously for potential impacts and trade-offs; validating generated plans against network safety constraints and performance objectives; and/or synthesizing the analysis into a comprehensive plan with multiple coordinated actions.

In some embodiments, the actionable plan includes implementation of device configuration changes across network switches, routers, or other network infrastructure components.

In some embodiments, automatically executing the actionable plan comprises at least one of: creating or modifying operators within a telemetry processing pipeline; constructing or modifying operator networks and directed acyclic graphs (DAGs) for processing workflows; establishing new time series monitoring systems for previously unmonitored metrics; implementing device configuration changes across network infrastructure components; creating an alert; or deploying new network intent specifications encoding operational objectives. In some such embodiments, creating or modifying operators comprises developing new filtering algorithms, analysis functions, or correlation operators tailored to the detected trigger condition.

In some embodiments, the method for generative AI-driven network optimization further comprises monitoring effectiveness of the executed actionable plan by tracking performance indicators before and after the execution of the actionable plan. In some such embodiments, the method for generative AI-driven network optimization further comprises incorporating into a knowledge base successful optimization strategies determined using the monitored effectiveness.

In some embodiments, the network environment is one of a plurality of network environments and wherein the contextual data is gathered from at least two network environments of the plurality of network environments.

In some embodiments, the network environment comprises nodes optimized for artificial intelligence workloads, and wherein the trigger event comprises detection of communication patterns associated with distributed machine learning training across the nodes. In some such embodiments, the communication patterns comprise at least one of all-to-all communication, collective operations, or bursty traffic patterns characteristic of machine learning training workloads.

In some embodiments, the one or more network components comprise network switches with Application-Specific Integrated Circuits (ASICs) running a networking operating system with telemetry processing operators. In some such embodiments, the network switches collect telemetry data at high frequency ranging from 1 to 10,000 Hz, the telemetry data comprising at least one of: packet flows, packet counts, and packet sizes; queue depths and buffer utilization; flow statistics and traffic patterns; congestion indicators and latency measurements; or protocol state changes.

In some embodiments, modifying the operational state comprises implementing dynamic load balancing by: adjusting dynamic load balancing parameters to redistribute traffic across multiple paths; configuring global load balancing settings to optimize traffic distribution; and implementing adaptive load balancing policies based on application workload characteristics.

In some embodiments, the contextual data includes telemetry information from at least one of: a storage; a distributed file system; a machine learning framework component; a container orchestration platform; a hardware accelerator; a graphics processing unit; a distributed training job scheduler; or a workload manager.

A system for generative AI-driven network optimization is described. The system includes one or more network switches configured to collect telemetry data and a server. The server is configured to detect a trigger event based on the collected telemetry data, gather contextual data in response to the trigger event, use a generative machine learning model to generate an actionable plan for modifying an operational state of a network environment based on the trigger event and the contextual data, and automatically execute the actionable plan by interfacing with one or more network components to modify the operational state of the network environment.

A computer program product for generative AI-driven network optimization is described. The computer program product comprises of instructions and includes one or more network switches configured to collect telemetry data and a server. The server is configured to detect a trigger event based on the collected telemetry data, gather contextual data in response to the trigger event, use a model (e.g. a rule based model, a generative machine learning model, a domain specific trained model) to generate an actionable plan for modifying an operational state of a network environment based on the trigger event and the contextual data, and automatically execute the actionable plan by interfacing with one or more network components to modify the operational state of the network environment.

In some embodiments, network performance is dynamically optimized using high-frequency telemetry collection, intelligent analysis, and near real-time configuration adjustments. For example, a network switch with enhanced telemetry capabilities continuously monitors network traffic at unprecedented granularity and frequency.

In some embodiments, the network switch includes hardware components that collect high-frequency telemetry data. Examples of telemetry data may include time series data on packet flows, packet counts, packet sizes, queue depths, buffer utilization, flow statistics, traffic patterns, error conditions, hardware state, congestion indicators, latency measurements, protocol state changes such as those related to routing, Link Layer Discovery Protocol (LLDP), L2 learning, or other protocols, etc. This high-frequency telemetry data is processed by an on-switch analytics engine that performs initial summarization/filtering. Either the switch and/or a network controller may perform classification of traffic patterns, detecting anomalies, congestion events, and performance bottlenecks as they emerge rather than after they impact application performance. The telemetry data (e.g., raw and/or filtered/summarized versions) is then transmitted to a centralized network controller via an optimized control channel. This channel is designed to maintain telemetry delivery even during periods of network congestion. The network controller employs one or more operators to analyze the telemetry data across multiple switches, correlating telemetry data and identifying optimization opportunities. Based on this analysis, the network controller generates configuration changes tailored to current network conditions and workload requirements. Examples of these configuration changes may include dynamic bandwidth allocation, priority queue adjustments, congestion control parameters, routing updates, and/or flow scheduling policies. The controller transmits these configuration instructions back to the network switches, which implement them in real-time. In various embodiments, the centralized network controller network is implemented on one or more servers for scalability and redundancy.

In some embodiments, a feedback mechanism exists whereby the switches report the effects of configuration changes, allowing the controller to evaluate their effectiveness and make further refinements. This closed-loop system continuously adapts to changing network conditions, providing autonomous optimization that exceeds what human operators could achieve manually. In some such embodiments, a hysteresis mechanism limits the speed at which modifications to a network are made (e.g., within a threshold period of time, until a threshold amount of data is gathered evaluating their effectiveness, etc.). For example, a user (e.g., a network administrator) configures a threshold number of consecutive evaluation cycles between state changes. Using the hysteresis mechanism, alert storms may be prevented or reduced, and state transitions may be made more stable. Thus, overall network stability may be improved, especially during modification, and changes to the network may be more thoroughly evaluated.

The method, system, and computer program product improve the computing system by automatically optimizing a network responsively and stably. In some embodiments, predictive capabilities are provided to anticipate network congestion before it occurs based on historical patterns and current traffic trends, enabling preemptive configuration adjustments that prevent performance degradation rather than merely reacting to it. By enabling networks to self-optimize in real-time, static network infrastructure is transformed into a dynamic, responsive system that adapts continuously to application needs, allowing a reduction in network latency, increased throughput, and improved application performance, particularly for latency-sensitive AI workloads with variable communication patterns. In some embodiments, model floating point operations per second (FLOPs) Utilization (MFU) is a key performance metric that is improved by the system. The MFU measures the efficiency of a graphical processing unit (GPU) during AI training, calculating the ratio of observed throughput to the theoretical peak FLOPS.

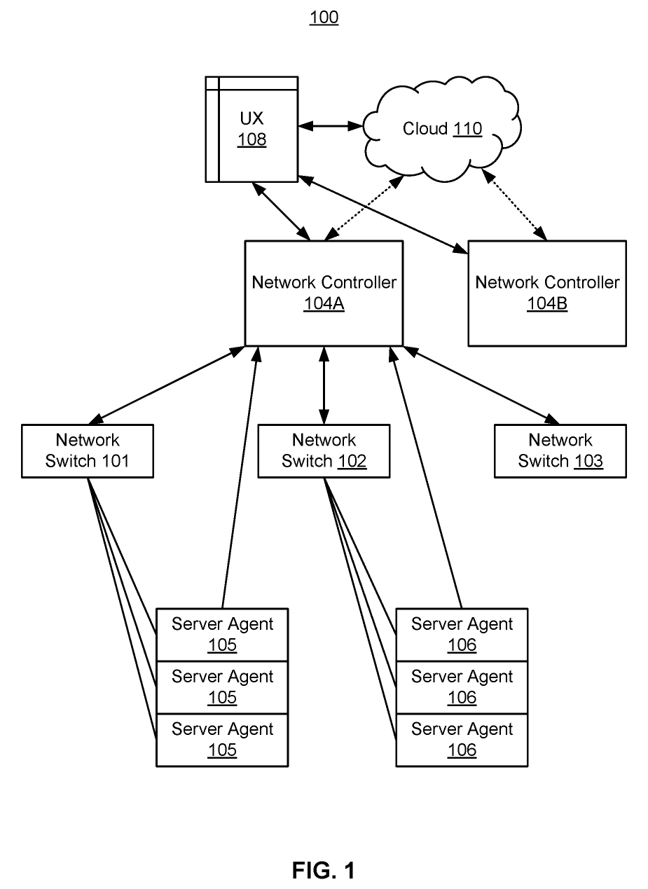

FIG. 1 is a diagram illustrating an embodiment of a system for generative AI-driven network optimization. System 100 includes network environments managed by network controller 104A and network controller 104B (e.g., collectively or generically, network controllers 104) in communication with cloud 110 and interfaced with by user interface (UX) 108 (e.g., by a user such as a network administrator). In the embodiment shown, network controller 104A is in communication with network switches 101, 102, and 103, which communicate with multiple servers via server agents 105 and 106. In various embodiments, any number of servers, server agents, network switches, network controllers, and network environments may be managed by system 100. Other configurations of networks and network environments may be used.

Network switches 101, 102, and 103 each include telemetry processing operators. By collecting, processing, and analyzing network telemetry data in real-time, dynamic network optimization is enabled. In some embodiments, network switches 101, 102, and 103 include one or more Application-Specific Integrated Circuits (ASICs) running a networking operating system (e.g., Software for Open Networking in the Cloud (SONiC)) with the telemetry processing operators. ASICs included in network switches 101, 102, and 103 may be interconnected via a high-speed internal fabric. Network switches 101, 102, and 103 perform network switching functionality such as Layer 2/3 forwarding, Virtual Local Area Network (VLAN) management, and routing protocol handling. Network switches 101, 102, and 103 each include a telemetry data processing framework that includes telemetry collection mechanisms and a programmable operator pipeline for filtering, summarizing, and/or analyzing the telemetry data. For example, telemetry data (e.g., time series data) is collected at a high frequency (e.g., 1-10,000Hz), and given the large amount of data collected, the telemetry data processing framework of network switches filters, summarizes, and/or compresses at least a portion of the collected data, if applicable, before sending the processed telemetry data to network controller 104A for analysis. In some embodiments, the network switches perform on-device analysis of received telemetry data and may perform a responsive action based on the analysis.

Network switches 101, 102, and 103 are connected to one or more servers and route network traffic to/from these server(s). In some embodiments, at least one of network switches 101, 102, and 103 receives data from these one or more servers that are processed by the telemetry data processing framework for action by the network switch and/or for delivery to network controller 104A for analysis and responsive action. For example, an agent on a network interface card (NIC) of a server collects telemetry information about system performance, network performance, and/or configurations (e.g., telemetry data on central processing unit (CPU), Graphics Processing Unit (GPU), memory, storage, hardware accelerator, ASIC, NIC, etc.). In FIG. 1, server agents 105 are each executed on different servers connected to network switch 101, and server agents 106 are each executed on different servers connected to network switch 102. In some embodiments, telemetry information of one or more servers are sent directly to network controller 104A (e.g., without being processed/analyzed by a network switch). In the embodiment shown, server agents 105 and server agents 106 transmit telemetry data directly to network controller 104A as well as to network switch 101 and network switch 102, respectively. The telemetry collection extends beyond just network switches and servers to encompass virtually any component within the AI stack, whether software or hardware. This comprehensive approach enables holistic optimization across the entire infrastructure. Examples of additional telemetry sources include:

Storage arrays and distributed file systems, providing insights into I/O patterns, throughput, and latency
AI framework components such as Simple Linux Utility for Resource Management (SLURM), NVIDIA Collective Communication Library (NCCL), PyTorch Distributed, and other communication libraries
Container orchestration platforms like Kubernetes, reporting on pod placement, resource utilization, and scheduling decisions
Hardware accelerators including GPUs, tensor processing units (TPUs), and specialized AI ASICs/chips with their utilization metrics and workload characteristics
Distributed training job schedulers and workload managers
Model serving platforms and inference engines
Data preprocessing pipelines and feature stores
Network fabric controllers and software-defined networking components

This expanded telemetry collection allows the system to correlate performance issues across multiple layers of the AI stack, identifying bottlenecks that might otherwise be invisible when monitoring network components in isolation.

Network controller 104A receives processed and unprocessed telemetry data from network switches 101, 102, and 103 and/or from one or more servers (e.g., from server agents 105/106) connected to at least one of network switches 101, 102, and 103 and stores the telemetry data in storage. Corresponding configuration and status of network switches 101, 102, and 103 are also received and stored in storage. These stored data may be analyzed using one or more operators. Results of the analysis may include one or more configuration changes (e.g., near real-time) to optimize the network. These changes are stored in configuration storage and pushed to network switches 101, 102, and 103 for implementation. The telemetry data and configuration data stored by network controller 104 is also pushed and stored long term in cloud 110. These stored data in cloud 110 may be analyzed using one or more operators (e.g., analogous to network controllers 104). In some embodiments, the operators of cloud 110 operate on a longer time frame than those of network controllers 104 and implement analysis and network changes on the longer time frame as compared to network controllers 104. For example, network controller 104A analyzes and implements network changes on the scale of sub-seconds, seconds, minutes, and hours and cloud 110 analyzes and implements network changes on the scale of days and weeks. In some embodiments, the operators of cloud 110 operate across multiple network environments. For example, network controller 104A and network controller 104B are associated with independent network fabrics. Cloud 110 is able to execute investigation tools of network controller 104A and network controller 104B in parallel and aggregate the results. A user (e.g., network administrator) can view and manage both network controllers 104 and cloud 110 via user interface 108.

In various embodiments, network switches 101, 102, and 103, network controllers 104, and/or cloud 110 utilize a telemetry data processing pipeline implemented through a directed acyclic graph (DAG) of operators. For example, the operator pipeline comprises multiple interconnected processing elements that transform telemetry data into actionable insights. Each operator in the pipeline represents a discrete processing function that may be implemented as compiled code, interpreted logic, rule-based systems, filtering mechanisms, decision points, or machine learning models including Large Language Models (LLMs) and domain specific models. In various embodiments, domain specific machine learning models include an orchestrator model for reasoning and tool selection, a specialist model for domain tasks including query generation and data interpretation, and a utility model for validation and grounding. For example, an optics assessment may use a two-phase specialist pipeline including query generation and domain expert interpretation. Operators connect to one another through interfaces, forming a flexible processing graph that can be reconfigured at runtime. In some embodiments, system 100 supports configuration of tool behavior, model selection, system prompts, and reasoning parameters without code changes. For example, configuration management through user interface 108 allows a user (e.g., a network administrator) to reconfigure the DAG of operators used by network controller 104A and the behavior of each operator. In some embodiments, the system supports dynamic reconfiguration of the telemetry processing pipeline. Pipeline reconfiguration allows components of system 100 to deploy new operators, modify existing ones, or reshape the processing graph to focus on emerging concerns.

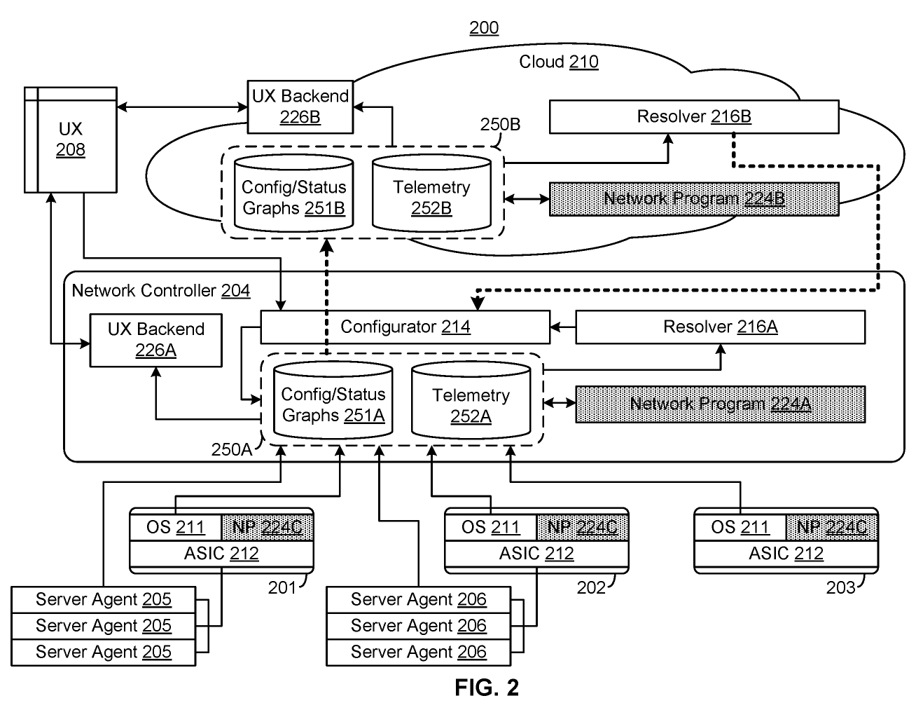

FIG. 2 is a diagram illustrating an embodiment of a system for generative AI-driven network optimization within a network environment. System 200 includes a network environment managed by network controller 204 in communication with cloud 210 and interfaced with by user interface 208 (e.g., by a user such as a network administrator). In the embodiment shown, network controller 204 is in communication with network switches 201, 202, and 203, which communicate with multiple servers via server agents 205 and 206. In various embodiments, any number of servers, server agents, network switches, network controllers, and network environments may be managed by system 200. Other configurations of networks and network environments may be used.

Network switches 201, 202, and 203 each include one or more Application-Specific Integrated Circuits (ASICs) 212 running a networking operating system 211 (e.g., Software for Open Networking in the Cloud (SONiC)) and network programs 224C with telemetry processing operators. By collecting, processing, and analyzing network telemetry data in real-time, dynamic network optimization is enabled. Network programs 224C of network switches 201, 202, and 203, network program 224A of network controller 204, and network program 224B of cloud 210 (e.g., collectively or generically, network programs 224) allow for communication between and coordination of the components of system 200 (e.g., via cloud 210, via user interface 208, etc.) to holistically improve the performance of the network environment. ASICs 212 included in the switch may be interconnected via a high-speed internal fabric. Network switches 201, 202, and 203 perform network switching functionality such as Layer 2/3 forwarding, VLAN management, and routing protocol handling. Network switches 201, 202, and 203 each include a telemetry data processing framework that includes telemetry collection mechanisms and the programmable operator pipeline for filtering, summarizing, and/or analyzing the telemetry data. For example, telemetry data (e.g., time series data) is collected at a high frequency (e.g., 1-10,000Hz), and given the large amount of data collected, the telemetry data processing framework of network switches filters, summarizes, and/or compresses at least a portion of the collected data, if applicable, before sending the processed telemetry data to network controller 204 for analysis. In the embodiment shown, data from network switches 201, 202, and 203 are sent to telemetry database 252A and config/status graphs database 251A within storage 250A. In some embodiments, the network switches perform on-device analysis of received telemetry data and may perform a responsive action based on the analysis. In some embodiments, fleet-wide anomaly detection (e.g., based on median, median absolute deviation (MAD), Z-score, etc.) is computed entirely within a single query of a database (e.g., telemetry database 252A, config/status graphs 251A, etc.). Thus, the processing load on network programs 224 may be reduced and scalability of system 200 may be improved. In various embodiments, system 200 manages any appropriate number of network environments and network components.

Network switches 201, 202, and 203 are connected to one or more servers and route network traffic to/from these server(s). In some embodiments, at least one of network switches 201, 202, and 203 receives data from these one or more servers that are processed by the telemetry data processing framework of the network switch for action by the network switch and/or for delivery to network controller 204 for analysis and responsive action. For example, an agent on a network interface card (NIC) of a server collects telemetry information about system performance, network performance, and/or configurations (e.g., telemetry data on CPU, GPU, memory, storage, hardware accelerator, ASIC, NIC, etc.). In FIG. 2, server agents 205 are each executed on different servers connected to network switch 201, and server agents 206 are each executed on different servers connected to network switch 202. In some embodiments, telemetry information of one or more servers are sent directly to network controller 204 (e.g., without being processed/analyzed by a network switch). The telemetry collection extends beyond just network switches and servers to encompass virtually any component within the AI stack, whether software or hardware. This comprehensive approach enables holistic optimization across the entire infrastructure. The expanded telemetry collection allows the system to correlate performance issues across multiple layers of the AI stack, identifying bottlenecks that might otherwise be invisible when monitoring network components in isolation.

Network controller 204 receives processed telemetry data from network switches 201, 202, and 203 and/or from one or more servers (e.g., from server agents 205/206) connected to at least one of network switches 201, 202, and 203 and stores the telemetry data in telemetry database 252A. Corresponding configuration and status of the switches are also received and stored in config/status graphs database 251A. These stored data are analyzed using one or more operators in resolver 216A. Results of resolver 216A may include one or more configuration changes (e.g., near real-time) to optimize the network. These changes are stored in config/status graphs database 251A and are pushed to the switches for implementation by configurator 214. The telemetry data and configuration data stored by network controller 204 is also pushed and stored long term in cloud 210. In the embodiment shown, storage 250B, including telemetry database 252B and config/status graphs database 251B, is analogous to storage 250A of network controller 204. In various embodiments, storage 250B includes data from other network controllers (e.g., from other network fabrics), data from a longer time frame as compared to data from storage 250A, or any other appropriate data. These stored data in cloud 210 are analyzed using one or more operators in resolver 216B. In some embodiments, resolver 216B operates on a longer time frame than resolver 216A of network controller 204 and implements analysis and network changes on the longer time frame as compared to network controller 204. For example, network controller 204 analyzes and implements network changes on the scale of sub-seconds, seconds, minutes, and hours and cloud 210 analyzes and implements network changes on the scale of days and weeks. In some embodiments, resolver 216B implements analysis and network changes using data from other network environments (e.g., from other network controllers). Results of resolver 216B may include one or more configuration changes to optimize the network. These changes are stored in config/status graphs database 251A and are pushed to the switches for implementation by configurator 214. Configurator 214 may interpret information provided by resolver 216A and/or resolver 216B (e.g., collectively or generically, resolvers 216) and implement changes to network components including or in communication with network controller 204 based on the interpretation. For example, one of resolvers 216 may determine an actionable plan to improve network performance involving configuration changes to network switches. Configurator 214 may implement the configuration changes on network switches 201, 202, and 203 based on the actionable plan. A user (e.g., network administrator) can view and manage both the network controller 204 and cloud 210 via user interface 208. Information is communicated via user interface backend 226A and user interface backend 226B, respectively.

In various embodiments, network switches 201, 202, and 203, network controller 204, and/or cloud 210 utilize a telemetry data processing pipeline implemented through a directed acyclic graph (DAG) of operators. For example, the operator pipeline comprises multiple interconnected processing elements that transform telemetry data into actionable insights. Each operator in the pipeline represents a discrete processing function that may be implemented as compiled code, interpreted logic, rule-based systems, filtering mechanisms, decision points, or machine learning models including Large Language Models (LLMs). Operators connect to one another through interfaces, forming a flexible processing graph that can be reconfigured at runtime. In some embodiments, the system supports dynamic reconfiguration of the telemetry processing pipeline. Pipeline reconfiguration allows the controller to deploy new operators, modify existing ones, or reshape the processing graph to focus on emerging concerns.

For example, an operator of a switch may perform initial transformations such as normalization, aggregation, and time-series alignment. These operators prepare the data for subsequent analysis while reducing its volume through intelligent summarization. Specific examples of telemetry data summarization/filtering include: statistical summarization through methods such as percentile calculation, moving averages, and variance detection; anomaly-based filtering that preferentially preserves outlier data while compressing normal patterns; temporal compression that adapts sampling rates based on detected rate of change; semantic aggregation that groups related metrics to provide contextual understanding; dimensional reduction through principal component analysis, etc. The summarization/filtering parameters may be dynamically adjusted based on network conditions, controller feedback, and observed patterns, ensuring that critical information is never lost while minimizing unnecessary data transmission.

Analysis performed by the operators of the network controller may include cross-switch correlation, historical trend analysis, determination of the current configuration and intended state of the network maintained on the network controller, and predictive modeling based on the summarized telemetry data received from multiple switches. For example, the network controller employs various analytical techniques including one or more of the following: topology-aware correlation that identifies patterns spanning multiple network elements; application fingerprinting that associates traffic patterns with specific workloads; predictive congestion modeling that anticipates network issues before they impact performance; configuration optimization that determines ideal settings for current and projected conditions; anomaly detection, pattern recognition; predictive modeling; classification; etc. For example, to perform topology-aware correlation, a host-centric topology view traces server connectivity through the fabric (e.g., from server to leaf ports to spine uplinks), detecting dual-homing status, path asymmetry, and capacity anomalies. Based on these analyses, the controller generates configuration changes that are transmitted back to the switches for immediate implementation. Examples of the responsive configuration changes include changes associated with: interface parameter adjustments such as speed, flow control, and buffering; quality of service policies including queue allocation and scheduling; routing and forwarding rules; traffic engineering parameters; congestion control mechanisms; etc.

In some embodiments, the network optimization and configuration changes involve intelligent load balancing. The system can dynamically configure and control advanced load balancing mechanisms such as dynamic load balancing and global load balancing (e.g., Broadcom’s Dynamic Load Balancing and Global Load Balancing) to minimize congestion and optimize performance. For example, by analyzing traffic patterns in real-time, the system can: adjust dynamic load balancing parameters to redistribute traffic across multiple paths in response to detected congestion; configure global load balancing settings to optimize traffic distribution across wider network domains; implement adaptive load balancing policies that adjust based on application workload characteristics; balance traffic between different tiers of the network fabric to prevent bottlenecks at aggregation points; and/or coordinate load balancing decisions with application-level communications libraries to align with collective operations in distributed AI training. These load balancing optimizations can be particularly effective for all-to-all communication patterns common in AI training workloads, helping to prevent localized congestion that would otherwise impact global application performance.

In some embodiments, in a closed-loop control system of continuous feedback between switches and the controller, each configuration change is monitored for effectiveness, with results reported back to the controller for evaluation and refinement. In some embodiments, based on the analysis of the telemetry data, hardware/software failures/maintenance windows are predicted, and action is taken to automatically route traffic around the failed elements and coordinate with maintenance teams and bring the elements back into operation without completely disrupting the workflows using the network. Specific examples include monitoring Optical Transceivers and their components for impending hardware failures or identifying/predicting software processes running protocols that have stopped responding.

In some embodiments, when monitoring optical transceivers, the system goes beyond just predicting failures by making intelligent decisions about link state management based on detailed telemetry data. For example, when analyzing optical transceiver telemetry, the system may: dynamically mark a link as down when optical power levels indicate degradation beyond acceptable thresholds, even before bit error rates rise to problematic levels; proactively reroute traffic away from links showing early warning signs of failure such as temperature fluctuations or voltage irregularities; keep links operational but with reduced bandwidth allocations when performance metrics indicate partial degradation; make informed decisions about whether to mark a link as up or down based on not just binary health indicators, but comprehensive telemetry data correlated with application performance requirements; and/or coordinate link state changes across multiple paths to ensure seamless traffic migration without causing congestion on alternative routes. This intelligent link management approach enables the network to maintain optimal performance even as hardware components approach failure thresholds, ensuring graceful degradation rather than sudden service interruptions.

In an exemplary embodiment, the system detects an emerging microbursts pattern in AI training traffic that threatens to overflow interface buffers. The switch's telemetry collectors identify the initial signs of queue growth, with preprocessing operators recognizing the pattern as potentially problematic. Summarization operators preserve the detailed characteristics of the microburst events while filtering out routine traffic patterns. This summarized data is transmitted to the controller, which correlates the observations across multiple switches and identifies the specific AI application causing the pattern. The controller's analysis operators determine that adjusting buffer allocation and enabling selective packet spraying would mitigate the issue. It generates configuration instructions implementing these changes and transmits them to the affected switches. The switches apply these configurations in real-time and monitor the results, confirming that buffer utilization has stabilized. This confirmation is reported back to the controller, which records the successful mitigation strategy for future reference. Throughout this process, the system operates autonomously, detecting and resolving potential performance issues before they impact application performance, demonstrating the system's capability for quick proactive network optimization.

### Generative AI-Driven Network Optimization

In some embodiments, the network optimization system incorporates a generative artificial intelligence (AI) solution that provides autonomous network management capabilities through intelligent trigger monitoring, contextual information gathering, generative planning, and automated generated plan execution. This generative AI solution extends the capabilities of the telemetry processing by introducing dynamic, context-aware decision-making that can adapt to novel network conditions and requirements without requiring pre-programmed rules or configurations.

In some embodiments, the generative AI solution includes: trigger monitoring, information gathering, plan generation/refinement, and plan execution. During the trigger monitoring phase, the generative AI solution continuously monitors the telemetry data streams, operator outputs, network performance metrics, and/or external events to identify conditions that warrant intelligent intervention. Examples of triggers include: detection of anomalous traffic patterns that do not match historical baselines; identification of performance degradation trends that may indicate emerging network issues; recognition of new application workload signatures that require specialized optimization strategies; notification of planned maintenance windows or hardware changes; detection of security events or network intrusions; identification of seasonal or cyclical traffic patterns requiring proactive resource allocation; recognition of operator pipeline failures or performance bottlenecks; detection of correlation patterns between disparate network events that suggest underlying systemic issues; and/or identification of opportunities for network configuration optimization based on long-term performance trends.

Upon trigger activation, the generative AI solution enters the information gathering phase, where it systematically collects additional contextual data relevant to the detected condition. This phase involves querying multiple data sources including: historical telemetry databases to understand baseline behaviors and trend patterns; current network topology and configuration states across all managed devices; application-level metrics from connected servers and workload managers; external data sources such as vendor advisories, security threat feeds, or weather reports that might impact network operations; operator performance logs and execution histories to understand past optimization attempts; network intent specifications and service level agreements that define operational objectives; and real-time correlation analysis between the trigger event and other concurrent network activities. In some embodiments, the information gathering phase includes setting up and connecting new data sources to the infrastructure or system. For example, logs are collected at a higher verbosity for specific modules or logging is enabled for new modules. In some embodiments, additional information is extracted directly from the ASIC(s) or other hardware component(s) to obtain new signals.

The plan generation and refinement phase leverages generative AI models, including large language models (LLMs) and/or specialized domain-specific AI models, to synthesize the gathered information into actionable optimization plans. The generative AI system analyzes the collected data in the context of network optimization objectives and generates comprehensive plans that may include multiple coordinated actions. The generative AI models may be trained on historical network optimization scenarios, best practices documentation, vendor specifications, and successful optimization patterns from similar network environments. The plan generation process considers multiple optimization strategies simultaneously and evaluates their potential impacts, trade-offs, and implementation requirements. Plans generated by the generative AI model are validated against network safety constraints, performance objectives, and/or operational policies before proceeding to execution.

The plan execution phase implements the generated optimization plan through automated actions across the network infrastructure. Examples of executable actions include: creation or modification of operators within the telemetry processing pipeline, including development of new filtering algorithms, analysis functions, or correlation operators tailored to the specific detected condition; construction or modification of operator networks and directed acyclic graphs (DAGs) to implement new processing workflows or optimize existing data paths for improved performance; establishment of new time series monitoring and tracking systems focused on previously unmonitored metrics or emerging patterns identified during the analysis phase; creation of new alert conditions and notification systems to proactively identify similar conditions in the future; implementation of device configuration changes across network switches, routers, and other infrastructure components, including parameter adjustments, policy updates, and feature enablement/disablement; and/or deployment of new network intent specifications that encode high-level operational objectives into enforceable network behaviors.

In some embodiments, the generative AI solution maintains a continuous learning capability whereby it monitors the effectiveness of implemented plans and incorporates successful optimization strategies into its knowledge base for future reference. The system tracks key performance indicators before and after plan execution, correlates outcomes with implementation details, and uses this feedback to refine its plan generation capabilities over time. This learning mechanism enables the system to become more effective at handling novel network conditions and to develop increasingly sophisticated optimization strategies based on operational experience.

The generative AI solution integrates seamlessly with the existing telemetry processing framework, serving as both a consumer of operator outputs and a generator of new operators and operator configurations. This integration enables the system to leverage existing network monitoring and control capabilities while extending them with intelligent, adaptive behaviors that can respond to previously unforeseen network conditions or requirements.

### Implementation Example: AI-Driven Performance Optimization for Distributed Training

Below are examples for one or more embodiments including five phases where the network is automatically optimized using the generative AI solution.

Phase 1: Initial Anomaly Detection by AI (AI monitoring Macro-level performance)

Input: The AI Network Management Core continuously ingests high-fidelity telemetry not just from network devices, but also directly from the distributed AI training framework through custom exporters integrated with PyTorch Distributed or Horovod. The system monitors critical application-level metrics including "average global step completion time," "GPU idle time," and "collective communication latencies such as NCCL AllReduce duration."

Anomaly Detection: In this example, the AI Core establishes a baseline for these metrics using time-series forecasting combined with outlier detection algorithms. The system identifies a consistent, statistically significant increase in the "average global step completion time" showing a 0.2-second creep, pushing the completion time from 1.7 seconds to 1.9 seconds, correlated with increased "GPU idle time" for a specific set of ranks. Notably, traditional network metrics such as Simple Network Management Protocol (SNMP) and basic NetFlow for the overall fabric remain within normal parameters, indicating that conventional monitoring would miss this performance degradation.

AI Hypothesis Generation: Based on its learned knowledge of AI workload characteristics, particularly that "AI training performance depends on tails and proceeds as quickly as its weakest link," the AI system generates the hypothesis: "Performance degradation indicates a hidden bottleneck, most likely a network tail latency issue affecting a subset of highly synchronized AI ranks."

Phase 2: AI-Driven Surgical Investigation with Dynamic Operators

The generative AI solution is used to identify suspect network domains. Action: The AI Core uses the application-level context, specifically that "GPU servers X, Y, Z are showing increased idle time," combined with its understanding of the network topology (e.g., symmetrical fabric with rail-optimized routing) to identify the specific leaf switches, spine switches, and their interconnects that service these affected GPUs. Automated Targeting: Instead of blanket-enabling high-fidelity telemetry everywhere, the AI system precisely identifies the 50-100 switches and 200-500 links within the potential communication paths of the affected GPU servers.

The generative AI solution injects and configures specialized in-device operators (e.g., Data Generators). Action: The AI Core, via the Orchestration Layer, automatically injects and activates two types of specialized inline operators onto the identified suspect switches and their ports. These operators perform localized data collection and initial summation.

Operator Type 1: Queue_Histogram_Operator
   Location: Injected on the egress port of each identified leaf switch, spine switch, and inter-switch link Logic (e.g., Inline): For all packets traversing the port, calculates and maintains a real-time histogram of:
      Instantaneous Queue Depth: Binned into fine-grained buckets (e.g., 0-1KB, 1-2KB, ..., 15-16KB)
      Packet Latency (e.g., within device): Time spent from ingress to egress through the switch, binned into microseconds
   Output (e.g., Exported Data - Summarized): Every 100ms, the operator exports a compressed representation of these histograms using sketches or specific percentiles like p50, p99, p99.9 queue depth and p50, p99, p99.9 packet latency
Operator Type 2: Flow_Completion_Time_Operator
   Location: Injected on the ingress and egress ports of leaf switches connecting to GPU servers, and potentially on key spine-to-spine links
   Logic (e.g., Inline): For each identified AI-relevant flow based on 5-tuple matching AI_JOB_ID_TAG or specific ports like NCCL 29400:
      Flow Start Detection: Records timestamp when the first packet of a new flow is seen
      Flow End Detection: Records timestamp when the last packet of a flow is seen using instruction byte (IB) opcodes or flow inactivity timeout
      Calculations: Calculates Flow_Completion_Time = (End - Start)
   Output (e.g., Exported Data - Event-based): Upon flow completion, exports Flow_ID, Source_NIC_ID, Destination_NIC_ID, and Flow_Completion_Time_μs

Configuration: AI is used to configure filters within both operators to focus on traffic types relevant to the AI job (e.g., specific subnets, remote direct memory access over converged ethernet version 2 (RoCEv2), user datagram protocol (UDP) port 29400). Operators are set to run for a duration corresponding to the next few training steps.

Phase 3: AI-Driven Comparison and Root Cause Identification

The generative AI solution is used to activate a centralized "Symmetry Comparison Operator" (e.g., Controller Operator). Location: This operator runs within the controller. It consumes the summarized data streamed from the numerous Queue_Histogram_Operator and Flow_Completion_Time_Operator time series.

Logic: The controller operator performs: Symmetry Grouping: Automatically groups network links/ports based on their logical symmetry, such as all uplinks from leaf switches in the same rack, all inter-spine links on the same "rail" Statistical Comparison: For each symmetry group, continuously compares the incoming histogram data (e.g., p99 queue depth, p99 latency, etc.) and flow completion times from each individual member against the group's statistical norm (e.g., mean and standard deviation) Outlier Detection: Identifies any single link, port, or source NIC where the p99 queue depth, p99 latency, or the distribution of flow completion times deviates significantly (e.g., 3 standard deviations, or a consistent shift in the tail of the flow completion time histogram) from its symmetrical peers within a recent time window (e.g., last 5 seconds) Correlation: Correlates observed network deviations with reported application performance degradation Output (e.g., Actionable Insight): Generates a high-confidence alert if an outlier is found, providing the specific link/port ID, the nature of the deviation (e.g., "elevated p99 queue depth," "slower flow completion times"), and the associated AI job/flows.

Identify the Root Cause: Real-time Analysis: The "Symmetry Comparison Operator" rapidly processes the incoming summaries. Precise Localization: Within seconds of receiving the new data, the AI identifies that the p99 queue depth histogram for Switch-Leaf-A, Port Eth1/10 (e.g., connected to AI-GPU-Server-K) shows a consistent, slight shift towards higher bins compared to its 99 symmetrical peers in Rack-1. Simultaneously, the Flow_Completion_Time_Operator data indicates that flows originating from AI-GPU-Server-K are consistently experiencing 50-100μs longer average completion times than flows from other servers in the same training job. This confirms the initial "weakest link" hypothesis. Deep Dive (e.g., Automated): The AI system automatically triggers the Flow_Completion_Time_Operator on Switch-Leaf-A, Port Eth1/10 to momentarily (e.g., 5 seconds) switch to a more verbose mode, streaming per-flow completion events to gather even finer-grained details on the affected flows, confirming micro-retries or small stalls impacting that specific NIC.

Phase 4: AI-Driven Remediation and Continuous Optimization

The generative AI solution is used to initiate or suggest a remediation plan: °oot Cause Identification: The AI Core correlates the specific network symptoms (e.g., elevated p99 queue, slower flow completion) with its knowledge base of common AI network issues, concluding: "Subtle degradation on AIGPUServer-K's NIC or its immediate link, causing tail latency that impacts synchronized collective communication." Automated Action (e.g., Tier 1): For such a clear and localized issue, the AI system autonomously triggers network and compute orchestration: Network-Side: The AI automatically signals the adaptive routing system to gently de-prioritize Switch-Leaf-A, Port Eth1/10 for new flows related to the affected AI job, shifting load to symmetrical, well-performing paths without disrupting existing flows

Compute-Side: Concurrently, the AI system tags AIGPUServer-K for proactive hardware diagnostics during the next maintenance window, notifying the compute orchestrator of a suspected NIC degradation to preempt a full failure Recommendation (e.g., Tier 2 - for human oversight): The AI generates a high-confidence recommendation for NetOps if manual intervention is required (e.g., a firmware update needed for the NIC). Multi-Step Agentic Workflows: The AI generates contextual, multi-step agentic workflows of corrective actions based on the telemetry and generated recommendations. The curated context of the scenario telemetry, recommendations, and appropriate system information is used to generate these custom execution plans on demand. These workflows are generated contextually to the observed scenario, with future plans to fine-tune general models and develop customer-specific models via reinforcement learning from human feedback (RLHF).

The generative AI solution is used to verify resolution and self-optimize: Automated Verification: The AI Network Management Core continues monitoring the global step completion time and GPU idle times, receiving ongoing data from the "Symmetry Comparison Operator." Observation: The "average global step completion time" for the LLM job gradually returns to its baseline 1.7s within minutes of the network adjustment. The p99 queue deviation on Switch-Leaf-A, Port Eth1/10 normalizes, and flow completion times from AIGPUServer-K align with its peers, causing anomaly alerts to cease. Self-Optimization: The AI Core learns from this successful resolution, reinforcing its models for detecting similar subtle divergences in symmetrical topologies and optimizing its automated response strategies. Operator Deactivation: Once stable performance is confirmed, the AI automatically disables and removes the injected Queue_Histogram_Operator and Flow_Completion_Time_Operator from the network devices, and stops the "Symmetry Comparison Operator," optimizing resource consumption.

Phase 5: Human Operator Evaluation and Learning

Natural Language Network Analysis: Users can perform current and historic network analysis via an LLM-enabled natural language query interface, allowing them to gain insights about their network without needing to write custom scripts.

Human Scoring for Future Remediations: Users can provide overall feedback and suggestions on the actions that the AI took for this resolution. The system incorporates that feedback and pushes it back into the remediation planning models via reinforcement learning, enabling the system to learn customer or environment-specific personalized remediation strategies rather than having general strategy for the same problem in all environments.

Agent Operator Observability: Users can oversee and orchestrate the dynamically instantiated agents operating on the network, providing human oversight of the automated optimization processes.

In another example, the generative AI solution detects an unusual traffic pattern during a distributed AI training job that exhibits characteristics not seen in historical data. The trigger monitoring phase identifies this anomaly based on deviation from expected collective communication patterns. During information gathering, the system queries the job scheduler to understand the specific AI model being trained, examines historical performance data for similar workloads, and correlates the traffic pattern with concurrent network events. The generative AI model analyzes this information and generates a plan that includes: creation of a new operator specifically designed to monitor and optimize for this type of traffic pattern; modification of the existing operator DAG to incorporate predictive buffering strategies; establishment of new time series tracking for job-specific performance metrics; creation of proactive alerts for similar workload patterns; and implementation of dynamic Quality of Service (QoS) policies tailored to the detected workload characteristics. The execution phase implements these changes automatically, and the system monitors the results to validate the effectiveness of the optimization strategy, incorporating successful elements into its knowledge base for future similar scenarios.

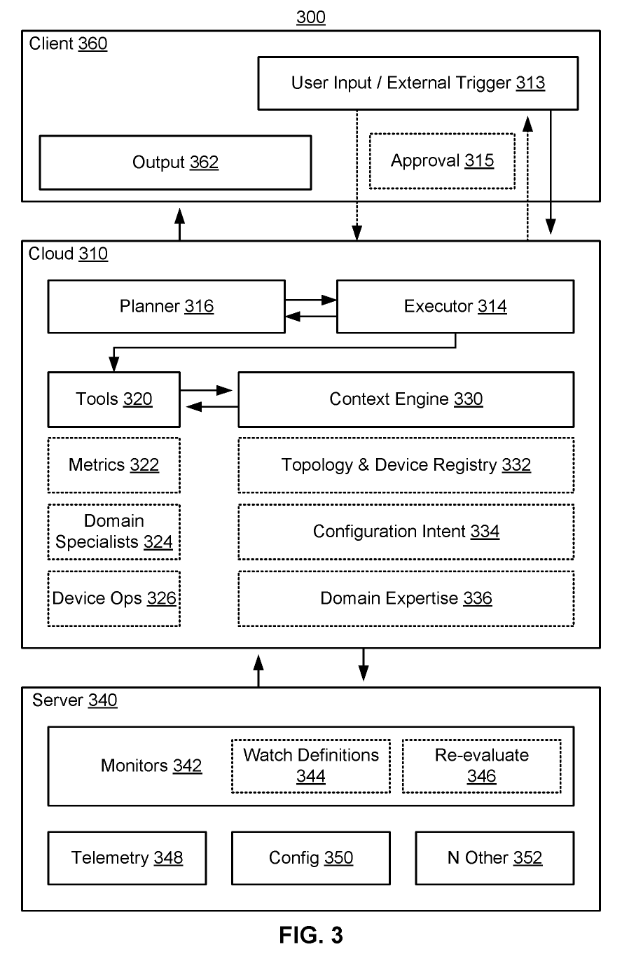

FIG. 3 is a diagram illustrating an embodiment of a workflow for generative AI-driven network optimization. In some embodiments, workflow 300 is implemented by system 100 of FIG. 1. In some embodiments, workflow 300 is implemented by system 200 of FIG. 2. In the embodiment shown, client 360 includes data accessed by a user (e.g., a network administrator) of a system implementing workflow 300. In various embodiments, the data is natural language data, visualizations of data (e.g., tables, graphs, etc.), or other appropriate human-readable data. For example, output 362 includes natural language summarization of network information and numeric data (e.g., derived from metrics queries 322, telemetry data 348, etc.) presented as a table to a user. In some embodiments, the user specifies the format and contents of output 362 (e.g., as a portion of user input / external trigger 313). User input / external trigger 313 includes natural language questions sent to cloud 310 and interpreted by a specialist model of domain specialists 324.

In some embodiments, output 362 includes a portion of an actionable plan for improving a network environment. In some such embodiments, in response to approval 315 being received as a portion of user input / external trigger 313, the actionable plan is implemented for the network environment. For example, planner 316 (e.g., analogous to resolver 216B of FIG. 2 in some embodiments) generates an actionable plan for a network environment based on contextual data and a trigger event. Executor 314 (e.g., analogous to configurator 214 of FIG. 2 in some embodiments) automatically implements a first portion of the actionable plan for the network environment via server 340. In response to receiving approval 315, executor 314 implements a remaining portion of the actionable plan.

Planner 316 and executor 314 utilize tools 320 in conjunction with context engine 330 and information received from server 340 to generate and automatically execute actionable plans to improve a network environment. In various embodiments, tools include metrics queries, topology inspection, connectivity probing, log analysis, optics assessment, fabric validation, device command execution, alert listing, or any other appropriate tool. In the embodiment shown, tools 320 includes metrics queries 322, domain specialists 324, and device ops 326. Context engine 330 includes topology & device registry 332, configuration intent 334, and domain expertise 336. Server 340 includes monitors 342 to gather telemetry data 348, config data 350, and N other information 352. Watch definitions 344 and re-evaluation 346 determine the behavior of monitors 342 and may be configured by a user (e.g., a network administrator).

Utilizing monitors 342, workflow 300 collects continuous numerical measurements from every device in the network and stores the measurements in a time-series database at high precision. In various embodiments, measurements include network or interface metrics, remote direct memory access (RDMA) or RDMA over converged ethernet (RoCE) metrics, optics metrics, system metrics, infrastructure metrics, compute metrics, or any other appropriate metrics. Examples of network or interface metrics include traffic counters, error rates, utilization, queue depths, and buffer usage. RDMA and RoCE metrics may include congestion notification rates, pause frame counters, and traffic volumes. Examples of optics metrics include forward error correction (FEC) error counters and digital optical monitoring readings such as signal power, temperature, and voltage. System metrics may include CPU usage, memory usage, disk usage, temperature, fan speed, and power. Examples of infrastructure metrics include routing session states, neighbor discovery, time synchronization, and domain name system (DNS) health. Compute metrics may include node, pod, and container resource usage, and deployment status.

In some embodiments, a monitoring engine implements monitors 342. Monitors 342 run scheduled queries against measurements including those described above. In various embodiments, monitors 342 detect when measurements exceed threshold values or when expected data stops arriving (e.g., deadman detection). Statistical methods like fleet-wide outlier scoring may be computed directly in database for efficiency and scalability.

In some embodiments, when planner 316 and executor 314 utilize tools 320, a specialist model (e.g., of domain specialists 324) translates natural language questions from user input / external trigger 313 into database queries targeting specific metric groups, devices, and time ranges. Results are returned in output 362 as structured data with visualization specifications.

Workflow 300 utilizes metric groupings including declarative configurations and computational pipelines that transform the raw measurements collected by server 340 into actionable intelligence. In various embodiments, watch definitions 344 includes named monitoring rules specifying which metrics to query, how often, what evaluator to apply, what thresholds trigger alerts, how much hysteresis to use before firing or resolving, or any other appropriate definitions. In some embodiments, telemetry data 348 is accessed via a telemetry processing pipeline. In some such embodiments, multi-step statistical computations are expressed declaratively and executed as a single database query rather than moving data into application code. For example, computing fleet medians, deviations, and per-device scores may be accomplished through single database queries. Examples of evaluators include threshold evaluators (e.g., if a metric exceeds a configurable value for a configurable number of consecutive evaluation cycles) and deadman evaluators (e.g., if no data is received for a configurable number of cycles). Each evaluator may maintain a per-watch state to prevent alert storms from transient spikes. Validation Checks may also be implemented by workflow 300, including layered comparisons of an observed operational state of the network against an intended state defined by configuration intent 334. The validation checks may be organized by network layer (e.g., provisioning to configuration to physical layer to data link layer to network layer), as lower-layer failures may cause higher-layer symptoms.

Utilizing metric groupings transforms the raw measurements of workflow 300 into semantic meaning. For example, output 362 may include context such as "this device is a statistical outlier relative to its fleet peers" rather than arbitrary numeric values. Workflow 300 may provide more robust alert lifecycle management through hysteresis and deduplication mechanisms defined in server 340 (e.g., re-evaluation 346). In some embodiments, processing measurements via context engine 330 of cloud 310 enables comparative fleet-wide analysis rather than per-device thresholds.

Context engine 330 includes general network knowledge. This knowledge may include structural and domain knowledge to provide context for interpreting metrics and alerts. In the embodiment shown, topology & device registry 332 includes a complete connectivity graph of all devices (e.g., spines, leaves, servers, etc.), their interconnections, interface states, and discovered neighbors. In some embodiments, cloud 310 assembles the connectivity graph by combining the intended design (e.g., as defined in configuration intent 334) with an observed state from telemetry data 348. In some embodiments, the connectivity graph may be analyzed at multiple levels of detail. For example, the graph may be analyzed as device-only, link-level, full (e.g., with all interfaces), and host-centric (e.g., tracing a server's path through the fabric). Topology & device registry 332 also includes identity mappings connecting device serial numbers to hostnames, roles, fabric membership, addresses, and any other appropriate information. The identity mappings may be injected into generative AI prompts to enable a model to ground its reasoning in specific device identities. Thus, using workflow 300, network optimizations may be made according to the characteristics of the particular environment and the network components involved.

Configuration intent 334 includes definitions of the intended network state. In various embodiments, configuration intent 334 includes what devices should exist, how they should be connected, what configuration they should have, or any other appropriate configuration information. Domain expertise 336 is embedded in system prompts and specialist agents including domain specialists 324. In various embodiments, domain expertise 336 includes FEC encoding expertise for optics health assessment, database schema and query pattern knowledge for metrics retrieval, leaf-spine fabric topology reasoning (e.g., dual-homing, path symmetry, capacity analysis, etc.), network operating system (OS) knowledge (e.g., interface naming, configuration models, log interpretation, etc.), diagnostic methodology (e.g., the ordering of diagnoses among provisioning, configuration, physical layer, data link layer, and network layer), or any other appropriate information.

Context engine 330 may be utilized by planner 316 and executor 314 to generate and execute an actionable plan specific to a network environment. For example, a metric anomaly on a specific port may be linked by planner 316 to the device it belongs to, that device's role in the fabric, and what downstream systems are affected. Context engine 330 provides structural reasoning: "this server is dual-homed to two switches, but one switch's upstream link is down, so all traffic is on a single path". Context engine 330 may also be used for monitoring and issuing trigger events. For example, error correction thresholds, congestion signaling mechanics, network-OS-specific troubleshooting, and other data in domain expertise 336 are used by server 340 to issue a trigger event specific to the network environment.

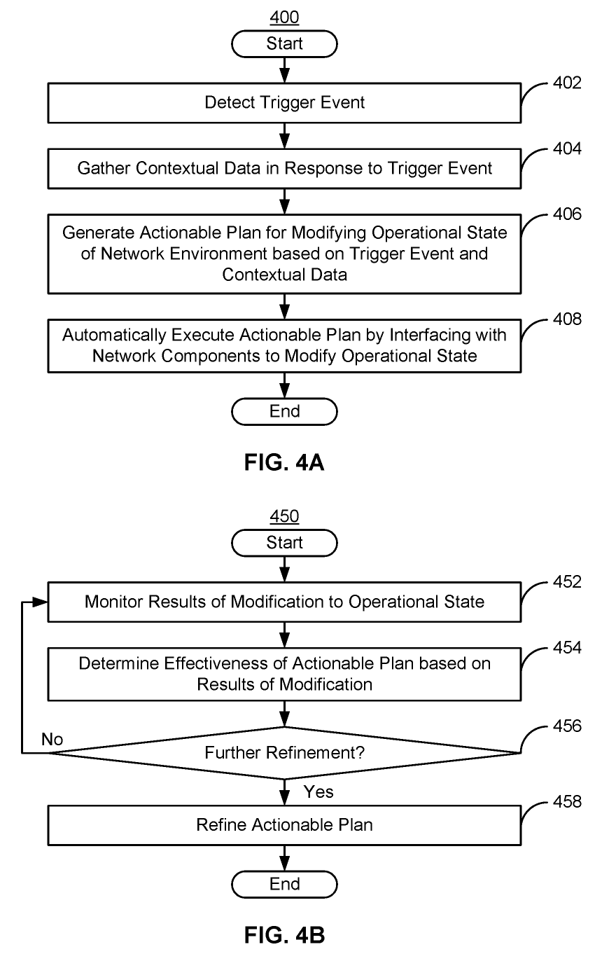

FIG. 4A is a flow diagram illustrating an embodiment of a process for generative AI-driven network optimization. In some embodiments, process 400 is implemented by a network program (e.g., network programs 224 of FIG. 2). Process 400 may utilize network components including switches (e.g., network switches 101, 102, and 103 of FIG. 1), network controllers (e.g., network controllers 104 of FIG. 1), or a cloud (e.g., cloud 110 of FIG. 1). In 402, a trigger event is detected. In 404, contextual data is gathered in response to the trigger event. In 406, an actionable plan is generated for modifying an operational state of a network environment based on the trigger event of 402 and the contextual data gathered in 404. The network environment may be one of multiple network environments or network fabrics. For example, a cloud-based system executing process 400 may generate an actionable plan for multiple network environments based on contextual data aggregated from all of the network environments. In 408, the actionable plan of 406 is automatically executed by interfacing with the network components of the network environment to modify the operational state.

Process 400 may be used to detect and reduce AI training performance degradation (e.g., via congestion straggler detection). In an example embodiment, a monitoring engine (e.g., monitors 342 of FIG. 3) runs a persistent statistical watch that computes fleet-wide outlier scores for RDMA congestion notification rates across all compute nodes every 30 seconds. One node's congestion rate deviates significantly (e.g., >3.5 standard deviations via Median Absolute Deviation) from its peers. After consecutive evaluation cycles confirm this isn't transient (hysteresis), an alert issues and is detected in 402. In 404, the system gathers contextual data including: the full alert payload (e.g., severity, device identity, metric values, etc.); the network topology graph (e.g., device roles, interconnections, interface states, etc.); a device registry mapping identifiers to hostnames; and historical metric baselines for the affected device and its peers. In 406, a generative AI model receives the gathered contextual data and has access to a suite of tools (e.g., metrics queries, topology inspection, connectivity probing, log analysis, optics assessment, fabric validation, device command execution, alert listing, etc.). The model reasons through the problem to generate an actionable plan, including querying time-series metrics (e.g., “Show congestion rates for this host vs. fleet over the last hour"), retrieving the host's connectivity path through the leaf-spine fabric, and identifying that the host has asymmetric spine reachability -- one upstream link is down, funneling all traffic through a single path and causing congestion. The model recommends assessing the physical layer health of the suspect link (e.g., FEC error analysis, optical signal quality, etc.), then running an automated link integrity test. In 408, the test executes on the device, and results confirm cable degradation. In some embodiments, a user (e.g., a system administrator) is sent the recommendation, and the test executes on the device in response to the user approving the recommendation. The cable is replaced, congestion normalizes, and the alert auto-resolves after the outlier score drops below threshold for the configured number of resolve cycles.

Process 400 may be used to fix configuration deployment failures. In an example embodiment, a configuration management system detects a failed configuration push to a network device and fires a critical alert with the device identity and failure description. The critical alert is detected in 402. In 404, an AI model retrieves deployment status across all devices, queries device logs around the failure time, and inspects the network topology for interface state. In 406, the model determines that the configuration references a non-existent interface (e.g., a breakout mode mismatch between intended and actual device state). It explains the root cause and recommends correcting the network intent configuration. In 408, the network intent configuration is fixed, the system re-pushes successfully, and the alert auto-resolves via version-gated resolution (e.g., success version >= failed version).

Process 400 may be used to proactively detect or anticipate degradation or failure of network components (e.g., optics degradation). In an example embodiment, a trigger event is detected in 402 indicating optics degradation. In various embodiments, the trigger event is based on an automated watch of forward error correction (FEC) counters, an operator query (e.g., "How are the optics looking across the fabric?"), or any other appropriate source. In 404, the system retrieves FEC counters (e.g., symbol errors, corrected/uncorrected codewords, etc.) and device topology data. In 406, a two-phase domain specialist process is used to generate the actionable plan: The system generates a time-series query to fetch FEC data, and a domain-expert model with knowledge of the specific FEC encoding standard (e.g., a Reed-Solomon RS(544,514) standard) computes pre-FEC bit error rate from raw counters and classifies each interface as healthy, degraded, or critical based on Institute of Electrical and Electronics Engineers (IEEE) thresholds. Two interfaces show elevated error rates approaching the FEC correction limit. The AI recommends targeted link integrity testing. In 408, the integrity testing is implemented and issues are resolved. Early detection prevents a hard link failure that would otherwise have disrupted AI training jobs.

Process 400 may be used to address provisioning failures. In an example embodiment, a provisioning service detects a device stuck during initial network bootstrap and fires an alert with the device serial number and provisioning stage. The alert is detected in 402. In 404, the system checks provisioning status across all devices (e.g., 2 of 12 stuck), retrieves bootstrap logs for the stuck devices, and probes network connectivity between the controller and the devices. Logs show dynamic host configuration protocol (DHCP) lease acquisition failed. The system correlates the logs with network topology information (e.g., topology & device registry 332 of FIG. 3) to identify the management switch and determines that the DHCP relay configuration is the source of the failure. In 408, the relay configuration is fixed, the devices complete provisioning, and the system confirms resolution.

Process 400 may be used to proactively verify symmetry of a network fabric. In an example embodiment, a trigger event is detected in 402 prompting the proactive fabric symmetry verification. In various embodiments, the trigger event is issued on a scheduled basis, in response to the provisioning of a new device, or in any other appropriate situation. In 404, the system checks that every server has equal-cost paths through the leaf-spine topology, that all expected links are up, and that no device has asymmetric upstream capacity. The system retrieves the full topology graph, compares the intended design to the observed operational state, determines interface operational status across all devices, and determines link-layer discovery protocol (LLDP) neighbor discovery results. The system also pulls traffic distribution metrics across parallel uplinks. The system compares intended topology against observed topology and identifies imbalances before they cause congestion. For example, the following summary may be determined in 406: "Leaf-04 has 8 spine uplinks configured but only 7 are operationally up. The 128 servers behind Leaf-04 currently have slightly uneven load distribution, but traffic levels are low enough that no congestion has occurred yet. When the next training job scales up, this asymmetry will create a bottleneck on the remaining 7 links." The system flags the down link for investigation (e.g., an optics check, a cable reseat, etc.) before any training job is affected. In 408, the flag is addressed during a maintenance window rather than during a production incident.

Process 400 may be used to integrate new network components into a network environment. In an example embodiment, process 400 performs pre-admission link validation for a new optics qualification. In various embodiments, a new optical transceiver is installed in a network fabric during initial deployment, as a replacement, or in any other appropriate situation. The system detects the new hardware in 402 via interface state change and digital optical monitoring (DOM) events before the link is brought up and advertised to routing protocols. In 404, the system reads the optic's DOM telemetry (e.g., transmission and receive (TX/RX) power levels, temperature, voltage, bias current) and retrieves the expected parameters for that interface type and speed. The system also identifies the link's role in the topology, including what devices are on each end and what traffic would traverse the link once the link becomes active. In 406, before allowing the link to participate in routing, the system automatically runs a PRBS (Pseudo-Random Bit Sequence) link integrity test to measure the actual bit error rate (BER) of the physical link end-to-end. It compares the measured BER against IEEE thresholds for the link speed and FEC encoding. In response to the optic passing the integrity test, the link is released to join the fabric in 408. In response to failure or marginal results, the link is held down, and the specific test results are used to determine a recommendation (e.g., reseat, clean, replace, etc.), executed in 408. In some embodiments, bad or misconfigured optics are prevented from entering the routing topology. This may prevent scenarios where a marginal optic attracts traffic and causes intermittent packet loss or cyclic redundancy check (CRC) errors. Such errors degrade training jobs and may be difficult to diagnose after the fact. As a result, using process 400, the system may better identify problems at the point of installation and prevent them from negatively impacting a production environment.

Process 400 may be used to proactively allocate resources based on learned traffic patterns. For example, the system observes that a distributed training job follows a predictable cyclical communication pattern – heavy all-to-all traffic during gradient synchronization phases, followed by quiet periods during forward/backward computation. In response, the system establishes a baseline profile for this workload's network behavior. In 402, the system detects that during synchronization phases, buffer utilization on certain spine links consistently reaches 70-80% of capacity – not yet causing issues but leaving minimal headroom (e.g., above a configurable threshold utilization level). In 404, the system correlates time-series metrics (e.g., interface utilization, queue depths, buffer occupancy, etc.) with the training job's step cadence, building a model of "normal" network demand at each phase of the training cycle. The system determines that if a second training job starts on the same fabric segment, the combined synchronization traffic will exceed buffer capacity and cause packet loss. In 406, The system proactively recommends buffer allocation adjustments and quality-of-service priority settings on the identified spine links to increase headroom, before a second job is scheduled. In 408, the allocation adjustments and priority settings are automatically applied. In some embodiments, the system flags to the workload scheduler that this fabric segment cannot safely absorb additional all-to-all traffic without risking the existing job's performance.

FIG. 4B is a flow diagram illustrating an embodiment of a process for generative AI-driven network optimization. In some embodiments, in addition to or in conjunction with process 400 of FIG. 4A, process 450 allows for closed-loop control for optimizing one or more network environments. In 452, results of a modification to the operational state of a network environment are monitored. In some embodiments, the results are monitored via network switches (e.g., analogous to network switches 101, 102, and 103 of FIG. 1). Other network components (e.g., a network controller, a network program in a cloud, a server agent, etc.) may monitor the results. In 454, based on the results of the modification monitored in 452, effectiveness of the actionable plan executed to produce the modification (e.g., the actionable plan executed in 408 of FIG. 4A) is determined. In 456, it is determined whether further refinement should occur based on the results of the modification monitored in 452 and the effectiveness of the actionable plan determined in 454. In various embodiments, the determination of 456 is based on a duration since the operational state was modified (e.g., whether the duration exceeds a threshold number of evaluation cycles, seconds, minutes, hours, days, etc.), a volume of data gathered in 452 or in 454, or any other appropriate criteria. In some such embodiments, this implements a hysteresis mechanism within process 450. Instability of network systems managed by process 450, especially during state transitions, may thus be reduced. In response to determining that further refinement should occur, control passes to 458. In response to determining that further refinement should not occur, control passes to 452. In 458, the actionable plan is refined based on the evaluation of 456, the results of the modification monitored in 452, and the effectiveness of the actionable plan determined in 454. In some embodiments, the actionable plan is then executed in a manner analogous to 408 of FIG. 4A. In some embodiments, a trigger event is created in response to determining that further refinement should occur, and the actionable plan is refined using process 400 of FIG. 4A.

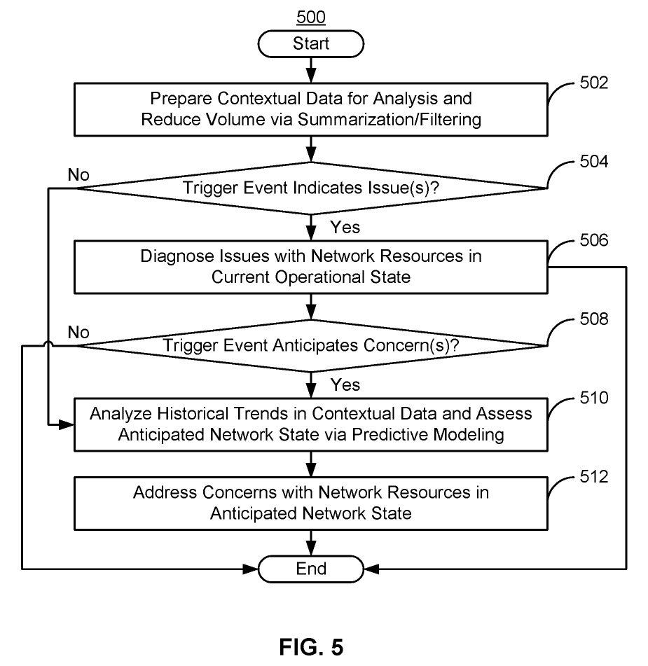

FIG. 5 is a flow diagram illustrating an embodiment of a process for generating an actionable plan for modifying the operational state of a network environment. In some embodiments, process 500 implements 406 of FIG. 4. In 502, contextual data is prepared for analysis and data volume is reduced via summarization and/or filtering. In some embodiments, the contextual data is processed by an analytics engine on a network switch. In various embodiments, a network switch, a network controller, a database, or any other appropriate network component perform one or more of classification of traffic patterns, anomaly detection, congestion detection, and performance evaluation in 502. In some embodiments, the contextual data (e.g., raw and/or filtered/summarized versions) is then transmitted to a centralized network controller (e.g., via an optimized control channel). In 504, it is determined whether a trigger event associated with the actionable plan generation indicates one or more issues with network resources in the current operational state of the network environment. For example, a monitoring system may automatically issue a trigger event in response to RDMA congestion above a threshold amount within a particular compute node, indicating an issue. In another example, a user of the network (e.g., a network administrator) prompts the system implementing process 500 (e.g., via a natural language query interface) to assess the network fabric for optics degradation, indicating a possible issue. In response to determining that the trigger event indicates one or more issues with the current operational state, control passes to 506. In response to determining that the trigger event does not indicate issues with the current operational state, control passes to 510.

In 506, the issues with network resources in the current operational state of the network environment are diagnosed. In some embodiments, process 500 enforces a diagnostic ordering addressing issues by layer (e.g., provisioning -> configuration -> physical -> data link -> network) based on the principle that lower-layer failures cause higher-layer symptoms. In some such embodiments, this troubleshooting methodology is embedded in AI tool definitions (e.g., in tools 320 of FIG. 3). In an example, in 506, an issue with network resource provisioning is addressed. A configuration issue is also identified, and a trigger event is generated in 506 to assess the ramifications of addressing the provisioning issue (e.g., in a subsequent iteration of process 500) on the configuration. In some embodiments, a hysteresis mechanism (e.g., analogous to that of process 450 of FIG. 4B) ensures that further refinement should occur before making subsequent changes to the network to address the configuration issue. Thus, using process 500, changes to the operational state of a network environment may be more effective at addressing root causes of issues and stability of the network may be improved.

In 508, it is determined whether the trigger event anticipates one or more concerns with network resources in a future operational state of the network environment. For example, in response to the provisioning of a new device, the system implementing process 500 automatically issues a trigger event proactively validating fabric symmetry before capacity imbalances or path asymmetry between devices can occur. In response to determining that the trigger event indicates future concerns, control passes to 510. In response to determining that the trigger event does not anticipate future concerns, process 500 terminates. In some embodiments, a trigger event both indicates issues in the current operational state and anticipates concerns in a future operational state. In 510, historical trends in the contextual data are analyzed and an anticipated network state is assessed via predictive modeling. In 512, the concerns with the network resources in the anticipated network state are addressed. In some embodiments, concerns are addressed in a manner analogous to the diagnosis of 506.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
detecting a trigger event;
in response to the trigger event, gathering contextual data;
using a generative machine learning model to generate an actionable plan for modifying an operational state of a network environment based on the trigger event and the contextual data; and
automatically executing the actionable plan by interfacing with one or more network components to modify the operational state of the network environment.

2. The method of claim 1, wherein detecting the trigger event comprises monitoring telemetry data streams from network switches and identifying at least one of: anomalous traffic patterns that deviate from historical baselines; performance degradation trends indicating emerging network issues; new application workload signatures requiring specialized optimization strategies; or correlation patterns between disparate network events suggesting systemic issues.

3. The method of claim 1, wherein gathering contextual data comprises querying data sources including one or more of: telemetry data associated with baseline behaviors and trend patterns; current network topology and configuration states across managed devices; application-level metrics from connected servers and workload managers; or real-time correlation analysis between the trigger event and concurrent network activities.

4. The method of claim 1, wherein the generative machine learning model is one of a plurality of domain specific machine learning models.

5. The method of claim 4, wherein the plurality of domain specific machine learning models includes at least one of: an orchestrator model for tool selection, a specialist model for domain tasks, and a utility model for validation.

6. The method of claim 1, wherein generating the actionable plan comprises using the generative machine learning model to perform one or more of: determining an analysis of the gathered contextual data in the context of network optimization objectives; evaluating multiple optimization strategies simultaneously for potential impacts and trade-offs; validating generated plans against network safety constraints and performance objectives; and/or synthesizing the analysis into a comprehensive plan with multiple coordinated actions.

7. The method of claim 1, wherein the actionable plan includes implementation of device configuration changes across network switches, routers, or other network infrastructure components.

8. The method of claim 1, wherein automatically executing the actionable plan comprises at least one of: creating or modifying operators within a telemetry processing pipeline; constructing or modifying operator networks and directed acyclic graphs (DAGs) for processing workflows; establishing new time series monitoring systems for previously unmonitored metrics; implementing device configuration changes across network infrastructure components; creating an alert; or deploying new network intent specifications encoding operational objectives.

9. The method of claim 8, wherein creating or modifying operators comprises developing new filtering algorithms, analysis functions, or correlation operators tailored to the trigger event.

10. The method of claim 1, further comprising: monitoring effectiveness of the executed actionable plan by tracking performance indicators before and after executing the actionable plan.

11. The method of claim 10, further comprising: incorporating into a knowledge base, successful optimization strategies determined using the monitored effectiveness.

12. The method of claim 1, wherein the network environment is one of a plurality of network environments and wherein the contextual data is gathered from at least two network environments of the plurality of network environments.

13. The method of claim 1, wherein the network environment comprises nodes optimized for artificial intelligence workloads, and wherein the trigger event comprises detection of communication patterns associated with distributed machine learning training across the nodes.

14. The method of claim 13, wherein the communication patterns comprise at least one of all-to-all communication, collective operations, or bursty traffic patterns characteristic of machine learning training workloads.

15. The method of claim 1, wherein the one or more network components comprise network switches with Application-Specific Integrated Circuits (ASICs) running a networking operating system with telemetry processing operators.

16. The method of claim 15, wherein the network switches collect telemetry data at high frequency ranging from 1 to 10,000 Hz, the telemetry data comprising at least one of: packet flows, packet counts, and packet sizes; queue depths and buffer utilization; flow statistics and traffic patterns; congestion indicators and latency measurements; or protocol state changes.

17. The method of claim 1, wherein modifying the operational state comprises implementing dynamic load balancing by: adjusting dynamic load balancing parameters to redistribute traffic across multiple paths; configuring global load balancing settings to optimize traffic distribution; and implementing adaptive load balancing policies based on application workload characteristics.

18. The method of claim 1, wherein the contextual data includes telemetry information from at least one of: a storage; a distributed file system; a machine learning framework component; a container orchestration platform; a hardware accelerator; a graphics processing unit; a distributed training job scheduler; or a workload manager.

19. A system comprising:
one or more network switches configured to collect telemetry data; and
a server configured to:
detect a trigger event based on the collected telemetry data;
in response to the trigger event, gather contextual data;
use a generative machine learning model to generate an actionable plan for modifying an operational state of a network environment based on the trigger event and the contextual data; and
automatically execute the actionable plan by interfacing with one or more network components to modify the operational state of the network environment.

20. A computer program product embodied in a non-transitory computer readable storage medium and comprising computer instructions for:
detecting a trigger event;
in response to the trigger event, gathering contextual data;
using a generative machine learning model to generate an actionable plan for modifying an operational state of a network environment based on the trigger event and the contextual data; and
automatically executing the actionable plan by interfacing with one or more network components to modify the operational state of the network environment.
